(19) United States
(12) Patent Application Publication
(10) Pub. No.: US 2004/0023826 A1
(43) Pub. Date: Feb. 5, 2004

(54) Water-soluble thermoformed containers comprising aqueous compositions

(76) Inventor: Paul John Duffield, Beverley (GB)

Correspondence Address: Andrew N Parfomak, Norris McLaughlin & Marcus, 30th Floor, 220 East 42nd Street, New York, NY, 10017, US

(21) Appl. No.: 10/362,631

(22) PCT Filed: Aug. 23, 2001
(86) PCT No.: PCT/GB01/03827

(30) Foreign Application Priority Data
Aug. 25, 2000 (GB) 0020965.0
Aug. 25, 2000 (GB) 0021113.6

(51) Int. Cl. C11D 17/00

(52) U.S. Cl. 510/295; 510/296; 510/439

(57) ABSTRACT

A water-soluble container containing an aqueous composition, wherein: a) the container comprises a thermoformed poly(vinyl alcohol) film; and b) the aqueous composition is in contact with the film and contains greater than 3 wt % free water, based on the weight of the aqueous composition.

The present invention relates to water-soluble containers containing aqueous compositions and to a process for preparing such compositions.

It is known to package chemical compositions which may be of a hazardous or irritant nature in water soluble or water dispersible material such as films. The package can simply be added to water in order to dissolve or disperse the contents of the package into the water.

For example, WO 89/12587 discloses a package which comprises an envelope of a water soluble or water dispersible material which comprises a flexible wall and a water-soluble or water-dispersible heat seal. The package may contain an organic liquid comprising, for example, a pesticide, fungicide, insecticide or herbicide.

It is also known to package detergents in water-soluble or water-dispersible containers. For example, WO 94/14941 discloses a water-soluble or water-dispersible capsule containing an aqueous dishwasher detergent. The capsule is made of gelatin.

CA-A-1,112,534 discloses a packet made of a water-soluble material in film form enclosing within it a paste-form, automatic dishwasher-compatible detergent composition. The water-soluble material may be, for example, poly(vinyl alcohol), polyethylene oxide or methyl cellulose. Example 1 illustrates an embodiment wherein a poly(vinyl alcohol)(PVOH) film is made into a 5 cm square packet by heat sealing its edges, and the packet is filled with a composition which contains 8.5 wt. % water.

In fields such as detergents for domestic use, an attractive appearance for an article is extremely desirable. However, in the prior art such as that described above, a bag is simply formed from a single sheet of water soluble film. The film is folded and three of the edges are heat-sealed to form the bag. The bag is then filled and the remaining edge heat sealed. This produces a rather flat, limp envelope containing the product. Furthermore there may be a lack of uniformity between different bags because of their flexible nature.

We have discovered that this type of product is not deemed to be attractive by an average consumer.

The present invention seeks to provide a water soluble container containing an aqueous composition, which container has a more attractive appearance. In particular the container should be relatively self-supporting and look full. Ideally the container should have an attractive, rounded three-dimensional appearance.

It is known to form water-soluble containers by thermoforming a water-soluble material. For example, WO 92/17382 discloses a package containing an agrochemical such as a pesticide comprising a first sheet of non-planar water-soluble or water-dispersible material and a second sheet of water-soluble or water-dispersible material superposed on the first sheet and sealed to it by a continuous closed water-soluble or water-dispersible seal along a continuous region of the superposed sheets. It is stated to be advantageous to ensure that the package produced is evacuated of air or the contents are under reduced pressure to provide increased resistance to shock. Furthermore, when the package contains a liquid, the liquid must be an organic liquid which must be reasonably dry and typically contains less than 2 to 3% of water to ensure that it does not attack the water-soluble package and cause leakage.

EP-A-654,418 describes self-standing flexible pouches which may contain, for example, liquid detergent compositions for refilling other containers. In order to avoid folding of the pouch, which can lead to cracking and leakage, the bag is inflated before it is sealed.

In order to improve the strength of packages containing liquids, it is also known to provide the package with residual inflatability. Thus, for example, EP-A-524,721 describes a water-soluble package which contains a liquid, wherein the package is inflatable to a volume which is greater than the initial volume of the package. Thus the package is filled to less than its complete capacity, and the unused capacity may be partially, but not totally, filled with a gas such as air. The unused capacity which does not contain gas provides the residual inflatability.

We have now surprisingly discovered a water-soluble container which contains a liquid composition can be given an attractive three-dimensional appearance by using a thermoforming technique such as that disclosed in WO 92/17382 on a PVOH film and ensuring that the liquid composition has a water content which is greater than that used before. Immediately after the containers are prepared, they have a limp, unattractive appearance. However, after storage for a short while, for example from a few minutes to a few hours, they develop a more attractive three-dimensional appearance, and also appear to look fuller. They can also be said to have a “puffed-up” appearance. Although not bound by this theory, it is believed that the water in the aqueous composition shrinks the PVOH film, which was stretched during the thermoforming process, around the liquid composition to provide the attractive appearance. In other words the PVOH film attempts to recover its original shape when contacted with the aqueous composition.

The present invention accordingly provides a water-soluble container containing an aqueous composition, wherein:

a) the container comprises a thermoformed PVOH film; and

b) the aqueous composition is in contact with the film and contains greater than 3 wt % free water, based on the weight of the aqueous composition.

The present invention also provides the use of a thermoformed PVOH film to package an aqueous composition containing greater than 3 wt % water, based on the weight of the aqueous composition.

The present invention further provides a process for producing a container as defined above which comprises:

a) thermoforming a first PVOH film to produce a pocket;

b) filling the pocket with the aqueous composition;

c) placing a second film, for example a PVOH film, on top of the filled pocket; and

d) sealing the first film and second film together.

There is no direct correlation between the actual amount of water present in a composition and the amount of free water as required in the present invention. Free water does not includes water which is not available to the PVOH film such as water held within a gelled matrix or water of salvation of any components present in the composition.

In order to determine the amount of free water present in a composition, a standard loss-on-drying determination test may be carried out. A sample of the composition, usually about 10 g, is weighed, and then maintained at 60° C. for 3 hours under a partial vacuum of 200 mbar (20 kPa). The sample is then re-weighed, and the weight lost determined. In the present invention, the loss on drying must be greater than 3 wt %, preferably greater than 4, 5, 6, 7, 8, 9, 10, 11, or 12 wt %, even more preferably greater than 20 wt % or greater than 30 wt %.

The method of forming the container is similar to the process described in WO 92/17382. A first PVOH film is initially thermoformed to produce a non-planar sheet containing a pocket, such as a recess, which is able to retain the aqueous composition. The pocket is generally bounded by a flange, which is preferably substantially planar. The pocket may have internal barrier layers as described in, for example, WO 93/08095. The pocket is then filled with the aqueous composition, and a second film, especially a PVOH film, is placed on the flange and across the pocket. The second film may or may not be thermoformed. If the first film contains more than one pocket, the second film may be placed across all of the pockets for convenience. The pocket may be completely filled, or only partly filled, for example to leave an air space of from 2 to 20%, especially from 5 to 10%, of the volume of the container immediately after it is formed. Partial filling may reduce the risk of rupture of the container if it is subjected to shock and reduce the risk of leakage if the container is subjected to high temperatures.

The films are then sealed together, for example by heat sealing across the flange. A suitable heat sealing temperature is, for example, 120 to 195° C., for example 140 to 150° C. A suitable sealing pressure is, for example, from 250 to 800 kPa. Examples of sealing pressures are 276 to 552 kPa (40 to 80 p.s.i.), especially 345 to 483 kPa (50 to 70 p.s.i.) or 400 to 800 kPa (4 to 8 bar), especially 500 to 700 kPa (5 to 7 bar) depending on the heat sealing machine used. Suitable sealing dwell times are at least 0.4 seconds, for example 0.4 to 2.5 seconds. Other methods of sealing the films together may be used, for example infra-red, radio frequency, ultrasonic, laser, solvent, vibration, electromagnetic, hot gas, hot plate, insert bonding, fraction sealing or spin welding. An adhesive such as water or an aqueous solution of PVOH may also be used. The adhesive can be applied to the films by spraying, transfer coating, roller coating or otherwise coating, or the films can be passed through a mist of the adhesive. The seal desirably is also water-soluble.

If more than one container is formed at the same time, the packaged compositions may then be separated from each other by cutting the flanges. Alternatively, they may be left conjoined and, for example, perforations provided between the individual containers so that they can be easily separated at a later stage, for example by a consumer. If the containers are separated, the flanges may be left in place. However, desirably the flanges are partially removed in order to provide an even more attractive, three-dimensional appearance. Generally the flanges remaining should be as small as possible for aesthetic purposes while bearing in mind that some flange is required to ensure the two films remain adhered to each other. A flange having a width of 1 mm to 10 mm is desirable, preferably 2 mm to 7 mm, more preferably 4 mm to 6 mm, most preferably about 5 mm.

The containers may then be left for a while to attain their attractive appearance, or may be immediately packaged into boxes for retail sale, and left to attain their attractive appearance in the boxes. The containers may themselves be packaged in outer containers if desired, for example non-water soluble containers which are removed before the water soluble containers are used.

If more than one PVOH film is used for the containers, the films may be identical or different. The PVOH film may be partially or fully alcoholised or hydrolysed, for example, it may be from 40 to 100%, preferably 70 to 92%, more preferably about 88% or about 92%, alcoholised or hydrolysed, polyvinyl acetate film. The degree of hydrolysis is known to influence the temperature at which the PVOH starts to dissolve in water. An example of a preferred PVOH is ethoxylated PVOH. 88% hydrolysis corresponds to a film soluble in cold (i.e. room temperature) water, whereas 92% hydrolysis corresponds to a film soluble in warm water. The film may be cast, blown or extruded. It may also be unorientated, mono-axially oriented or bi-axially oriented.

The PVOH film may be a film which contains water. All commercially available PVOH film contains about 6 to 14% water. It may also be a film having a water content of less than 5 wt % (herein sometimes referred to as an anhydrous film). Desirably the film has a water content of less than 3 wt %, 2 wt % or even 1 wt %. In general it is difficult to obtain a totally anhydrous PVOH film, but desirably the film contains more than 0.1 wt % water, for example more than 0.5 wt % or more than 1 wt % water, to ensure the film is not too brittle. Most preferably the film contains 0.5 to 1 wt % water. The amount of water required to ensure that the film is not too brittle depends to a certain extent on the amount of plasticiser in the film.

A blown PVOH film initially contains a very low proportion of water and can be considered to be anhydrous. However, it rapidly absorbs water from the atmosphere until it contains around 8 wt % water or even more. It is therefore possible to obtain an anhydrous PVOH film by immediately wrapping a blown PVOH film in packaging which prevents moisture absorption, such as a polyethylene film. Another possibility is to carry out the thermoforming process on a PVOH blown film immediately after it has been prepared. A further possibility is to dry a blown or cast PVOH film by storing it open under reduced humidity conditions, although this may not be commercially economic.

Since an anhydrous PVOH film has a degree of shape and size stability, it does not immediately shrink after thermoforming unlike conventional PVOH film. Therefore it does not have to be immediately filled.

Desirably the first PVOH film is anhydrous. The second PVOH film may be anhydrous, but is desirably a conventional film having a water content of from 6 to 14% or 18%.

It is possible for suitable additives such as plasticisers, lubricants and colouring agents to be added to the film. Components which modify the properties of the polymer may also be added. Plasticisers are generally used in an amount of up to 35 wt %, for example from 5 to 35 wt %, preferably from 7 to 20 wt %, more preferably from 10 to 15 wt %. Lubricants are generally used in an amount of 0.5 to 5 wt %. The polymer is therefore generally used in an amount of from 60 to 94.5 wt %, based on the total amount of the composition used to form the film. Suitable plasticisers are, for example, pentaerythritols such as depentaerythritol, sorbitol, mannitol, glycerine and glycols such as glycerol, ethylene glycol and polyethylene glycol. Solids such as talc, stearic acid, magnesium stearate, silicon dioxide, zinc stearate or colloidal silica may also be used.

It is also possible to include one or more particulate solids in the films in order to accelerate the rate of dissolution of the container. This solid may also be present in the contents of the container. Dissolution of the solid in water is sufficient to cause an acceleration in the break-up of the container, particularly if a gas is generated, when the physical agitation caused may, for example, result in the virtually immediate release of the contents from the container. Examples of such solids are alkali or alkaline earth metal, such as sodium, potassium, magnesium or calcium, bicarbonate or carbonate, in conjunction with an acid. Suitable acids are, for example, acidic substances having carboxylic or sulfonic acid groups or salts thereof. Examples are cinnamic, tartaric, mandelic, fumaric, maleic, malic, palmoic, citric and naphthalene disulfonic acids.

The film is generally cold water (20° C.) soluble, but, depending on its degree of hydrolysis, may be insoluble in cold water at 20° C. and only become soluble in warm water or hot water having a temperature of, for example, 30° C., 40° C., 50° C. or even 60° C. If the film is soluble in cold water, or water at a temperature of up to, say, 35° C. steps must be taken to ensure that the aqueous composition contained inside the container does not dissolve the film from the inside. Steps may be taken to treat the inside surface of the film, for example by coating it with a semi-permeable or partial water barrier such as polyethylene or polypropylene or a hydrogel such as a polyacrylate. This coating will simply fall apart or dissolve or disperse into microscopic particles when the container is dissolved in water. Steps may also be taken to adapt the composition to ensure that it does not dissolve the film. For example, it has been found that ensuring the composition has a high ionic strength or contains an agent which minimises water loss through the walls of the container will prevent the composition from dissolving the PVOH film from the inside. This is described in more detail in EP-A-518,689 and WO 97/27743.

It is particularly important to avoid pinholes in the film through which leakage of the contained composition may occur. It may therefore be appropriate to use a laminate of two or more layers of a different or the same PVOH film, as pinholes are unlikely to coincide in two layers of material. When a first and second PVOH film are used to form the containers of the present invention, the first PVOH film will generally have a thickness before thermoforming of 20 to 500 μm, especially 70 to 400 μm, for example 70 to 300 μm, most preferably 70 to 160 μm, especially 75 to 100 μm or 90 or 110 to 150 μm. The thickness of the second PVOH film may be less than that of the first film as the second film will not generally be thermoformed so localised thinning of the sheet will not occur. The thickness of the second film will generally be from 20 to 150 or 160 μm, preferably from 40 or 50 to 90 or 100 μm, more preferably from 50 to 80 μm.

The films may be chosen, if desired, such that they have the same thickness before the first film is thermoformed, or have the same thickness after the first sheet has been thermoformed in order to provide a composition which is encapsulated by a substantially constant thickness of film.

The containers of the present invention generally contain from 5 to 100 g of aqueous composition, especially from 15 to 40 g, depending on their intended use. For example, a dishwashing composition may weigh from 15 to 20 g, a water-softening composition may weigh from 25 to 35 g, and a laundry composition may weigh from 10 to 40 g, especially 20 to 30 g or 30 to 40 g.

The containers may have any shape achievable by thermoforming. For example they can take the form of a cylinder, cube or cuboid, i.e. a rectangular parallelepiped whose faces are not all equal. In general, because the containers are not rigid, the sides are not planar, but rather are convex. If the container is formed from a thermoformed PVOH film and a planar PVOH film, the seam between the two films will appear nearer one face of the container rather than the other. Apart from the deformation of the container due to the shrinkage of the PVOH film discussed above, deformation may also occur at the stage of manufacture if desired. For example, if the pocket is filled with a gelled composition having a height greater than that of the pocket, the second film will be deformed when placed on top of the pocket.

In general the maximum dimension of the filled part of the container (excluding any flanges) is 5 cm. For example, a rounded cuboid container may have a length of 1 to 5 cm, especially 3.5 to 4.5 cm, a width of 1.5 to 3.5 cm, especially 2 to 3 cm, and a height of 1 to 2.5, especially 1 to 2 cm, for example 1.25 to 1.75 cm.

The container of the present invention desirably contains an aqueous composition which is a fabric care, surface care or dishwashing composition. Thus, for example, it may be a dishwashing, water-softening, laundry or detergent composition or a rinse aid. In this case the container is preferably suitable for use in a domestic washing machine such as a laundry washing machine or a dishwashing machine. The composition may also be a disinfectant, antibacterial or antiseptic composition intended to be diluted with water before use, or a concentrated refill composition, for example for a trigger-type spray used in domestic situations. Such a composition can simply be added to water already held in the spray container. Examples of surface care compositions are those used to clean, treat or polish a surface. Suitable surfaces are, for example, household surfaces such as worktops, as well as surfaces of sanitary ware, such as sinks, basins and lavatories.

The composition contains greater than 3 wt % free water based on the weight of the aqueous composition, in order to ensure that the container has an attractive appearance. However, the actual amount of water present in the composition may be in excess of the amount of free water since the total water content includes water of salvation and water held within a gelled matrix. The total amount of water is generally more than 5 wt %, for example more than 10, 15, 20, 25 or 30 wt %. The total water content may be less than 80 wt %, for example less than 70, 60, 50, 40 wt %. It may, for example, contain from 30 to 65 wt % total water.

The remaining ingredients of the aqueous composition depend on the use of the composition. Thus, for example, the compositions may contain surface active agents such as an anionic, nonionic, cationic, amphoteric or zwitterionic surface active agents or mixtures thereof.

Examples of anionic surfactants are straight-chained or branched alkyl sulfates and alkyl polyalkoxylated sulfates, also known as alkyl ether sulfates. Such surfactants may be produced by the sulfation of higher C₈-C₂₀ fatty alcohols.

Examples of primary alkyl sulfate surfactants are those of formula:

ROSO₃⁻M⁺

wherein R is a linear C₈-C₂₀ hydrocarbyl group and M is a water-solubilising cation. Preferably R is C₁₀-Cl₆ alkyl, for example C₁₂-C₁₄, and M is alkali metal such as lithium, sodium or potassium.

Examples of secondary alkyl sulfate surfactants are those which have the sulfate moiety on a “backbone” of the molecule, for example those of formula:

CH₂(CH₂)ₙ(CHOSO₃⁻M⁺)(CH₂)ₘCH₃

wherein m and n are independently 2 or more, the sum of m+n typically being 6 to 20, for example 9 to 15, and M is a water-solubilising cation such as lithium, sodium or potassium.

Especially preferred secondary alkyl sulfates are the (2,3) alkyl sulfate surfactants of formulae:

CH₂(CH₂)ₓ(CHOSO₃⁻M⁺)CH₃ and

CH₃(CH₂)ₓ(CHOSO₃⁻M⁺)CH₂CH₃

for the 2-sulfate and 3-sulfate, respectively. In these formulae x is at least 4, for example 6 to 20, preferably 10 to 16. M is cation, such as an alkali metal, for example lithium, sodium or potassium.

Examples of alkoxylated alkyl sulfates are ethoxylated alkyl sulfates of the formula:

RO(C₂H₄O)ₙSO₃⁻M⁺

wherein R is a C₈-C₂₀ alkyl group, preferably C₁₀-C₁₈ such as a C₁₂-C₁₆, n is at least 1, for example from 1 to 20, preferably 1 to 15, especially 1 to 6, and M is a salt-forming cation such as lithium, sodium, potassium, ammonium, alkylammonium or alkanolammonium. These compounds can provide especially desirable fabric cleaning performance benefits when used in combination with alkyl sulfates. The alkyl sulfates and alkyl ether sulfates will generally be used in the form of mixtures comprising varying alkyl chain lengths and, if present, varying degrees of alkoxylation.

Other anionic surfactants which may be employed are salts of fatty acids, for example C₈-C₁₈ fatty acids, especially the sodium, potassium or alkanolammonium salts, and alkyl, for example C₈-C₁₈, benzene sulfonates.

Examples of nonionic surfactants are fatty acid alkoxylates, such as fatty acid ethoxylates, especially those of formula:

R(C₂H₄O)ₙOH

wherein R is a straight or branched C₈-C₁₆ alkyl group, preferably a C₉-C₁₅, for example C ₁₀-C₁₄ or C₁₂-C₁₄, alkyl group and n is at least 1, for example from 1 to 16, preferably 2 to 12, more preferably 3 to 10.

The alkoxylated fatty alcohol nonionic surfactant will frequently have a hydrophilic-lipophilic balance (HLB) which ranges from 3 to 17, more preferably from 6 to 15, most preferably from 10 to 15.

Examples of fatty alcohol ethoxylates are those made from alcohols of 12 to 15 carbon atoms and which contain about 7 moles of ethylene oxide. Such materials are commercially marketed under the trademarks Neodol 25-7 and Neodol 23-6.5 by Shell Chemical Company. Other useful Neodols include Neodol 1-5, an ethoxylated fatty alcohol averaging 11 carbon atoms in its alkyl chain with about 5 moles of ethylene oxide; Neodol 23-9, an ethoxylated primary C₁₂-C₁₃ alcohol having about 9 moles of ethylene oxide; and Neodol 91-10, an ethoxylated C₉-C₁₁, primary alcohol having about 10 moles of ethylene oxide. Alcohol ethoxylates of this type have also been marketed by Shell Chemical Company under the Dobanol trademark. Dobanol 91-5 is an ethoxylated C₉-C₁₁ fatty alcohol with an average of 5 moles ethylene oxide and Dobanol 25-7 is an ethoxylated Cl₂-C₁₅ fatty alcohol with an average of 7 moles of ethylene oxide per mole of fatty alcohol.

Other examples of suitable ethoxylated alcohol nonionic surfactants include Tergitol 15-S-7 and Tergitol 15-S-9, both of which are linear secondary alcohol ethoxylates available from Union Carbide Corporation. Tergitol 15-S-7 is a mixed ethoxylated product of a C₁₁-C₁₅ linear secondary alkanol with 7 moles of ethylene oxide and Tergitol 15-S-9 is the same but with 9 moles of ethylene oxide.

Other suitable alcohol ethoxylated nonionic surfactants are Neodol 45-11, which is a similar ethylene oxide condensation products of a fatty alcohol having 14-15 carbon atoms and the number of ethylene oxide groups per mole being about 11. Such products are also available from Shell Chemical Company.

Further nonionic surfactants are, for example, C₁₀-C₁₈ alkyl polyglycosides, such as C₁₂-C₁₆ alkyl polyglycosides, especially the polyglucosides. These are especially useful when high foaming compositions are desired. Further surfactants are polyhydroxy fatty acid amides, such as C₁₀-C₁₈ N-(3-methoxypropyl) glycamides and ethylene oxide-propylene oxide block polymers of the Pluronic type.

Examples of cationic surfactants are those of the quaternary ammonium type

Examples of amphoteric surfactants are C₁₀-C₁₈ amine oxides and the C₁₂-C₁₈ betaines and sulfobetaines.

The total content of surfactants in the composition is desirably 0.1 to 95 wt %, especially 60 or 75 to 90 wt %. The total content of surfactants in a laundry or detergent composition is desirably 60 to 95 wt %, especially 75 to 90 wt %. Desirably, especially in a laundry composition, an anionic surfactant is present in an amount of 50 to 75 wt %, a nonionic surfactant is present in an amount of 5 to 20 wt %, a cationic surfactant is present in an amount of from 0 to 10 wt % and/or an amphoteric surfactant is present in an amount of from 0 to 10 wt %. Desirably, in a dishwashing composition, the anionic surfactant is present in an amount of from 0.1 to 50 wt %, a non-ionic surfactant is present in an amount of 0.5 to 20 wt % and/or a cationic surfactant is present in an amount of from 1 to 15 wt %. The amounts are based on the total solids content of the composition, i.e. excluding the water or solvent which is present.

The compositions, particularly when used as laundry washing or dishwashing compositions, may also comprise enzymes, such as protease, lipase, amylase, cellulase and peroxidase enzymes. Such enzymes are commercially available and sold, for example, under the registered trade marks Esperase, Alcalase, Savinase, Termanyl, Lipolase and Celluzyme by Nova Industries A/S and Maxatasc by International Biosynthetics, Inc. Desirably the enzymes are present in the composition in an amount of from 0.5 to 3 wt %, especially 1 to 2 wt %.

The compositions may, if desired, comprise a thickening agent or gelling agent. Suitable thickeners are polyacrylate polymers such as those sold under the trade mark CARBOPOL, or the trade mark ACUSOL by Rohm and Haas Company. Other suitable thickeners are xanthan gums. The thickener, if present, is generally present in an amount of from 0.2 to 4 wt %, especially 0.5 to 2 wt %.

Dishwasher compositions usually comprisea detergency builder. Suitable builders are alkali metal or ammonium phosphates, polyphosphates, phosphonates, polyphosphonates, carbonates, bicarbonates, borates, polyhydroxysulfonates, polyacetates, carboxylates, and polycarboxylates such as citrates. The builder is desirably present in an amount of up to 90 wt %, preferably 15 to 90 wt %, more preferably 15 to 75 wt %, relative to the total content of the composition. Further details of suitable components are given in, for example, EP-A-694,059, EP-A-518,720 and WO 99/06522.

The compositions can also optionally comprise one or more additional ingredients. These include conventional detergent composition components such as further surfactants, bleaches, bleach enhancing agents, builders, suds boosters or suds suppressors, anti-tarnish and anti-corrosion agents, organic solvents, co-solvents, phase stabilisers, emulsifying agents, preservatives, soil suspending agents, soil release agents, germicides, phosphates such as sodium tripolyphosphate or potassium tripolyphosphate, pH adjusting agents or buffers, non-builder alkalinity sources, chelating agents, clays such as smectite clays, enzyme stabilizers, anti-limescale agents, colourants, dyes, hydrotropes, dye transfer inhibiting agents, brighteners and perfumes. If used, such optional ingredients will generally constitute no more than 10 wt %, for example from 1 to 6 wt %, of the total weight of the compositions.

The builders counteract the effects of calcium, or other ion, water hardness encountered during laundering or bleaching use of the compositions herein. Examples of such materials are citrate, succinate, malonate, carboxymethyl succinate, carboxylate, polycarboxylate and polyacetyl carboxylate salts, for example with alkali metal or alkaline earth metal cations, or the corresponding free acids. Specific examples are sodium, potassium and lithium salts of oxydisuccinic acid, mellitic acid, benzene polycarboxylic acids, C₁₀-c₂₂ fatty acids and citric acid. Other examples are organic phosphonate type sequestering agents such as those sold by Monsanto under the trade mark Dequest and alkylhydroxy phosphonates. Citrate salts and C₁₂-C₁₈ fatty acid soaps are preferred.

Other suitable builders are polymers and copolymers known to have builder properties. For example, such materials include appropriate polyacrylic acid, polymaleic acid, and polyacrylic/polymaleic and copolymers and their salts, such as those sold by BASF under the trade mark Sokalan.

The builders generally constitute from 0 to 3 wt %, more preferably from 0.1 to 1 wt %, by weight of the compositions.

Compositions which comprise an enzyme may optionally contain materials which maintain the stability of the enzyme. Such enzyme stabilizers include, for example, polyols such as propylene glycol, boric acid and borax. Combinations of these enzyme stabilizers may also be employed. If utilized, the enzyme stabilizers generally constitute from 0.1 to 1 wt % of the compositions.

The compositions may optionally comprise materials which serve as phase stabilizers and/or co-solvents. Example are C₁-C₃ alcohols or diols such as methanol, ethanol, propanol and 1,2-propanediol. C₁-C₃ alkanolamines such as mono-, di- and triethanolamines and mono isopropanolamine can also be used, by themselves or in combination with the alcohols. The phase stabilizers and/or co-solvents can, for example, constitute 0 to 1 wt %, preferably 0.1 to 0.5 wt %, of the composition.

The compositions may optionally comprise components which adjust or maintain the pH of the compositions at optimum levels. Examples of pH adjusting agents are NaOH and citric acid. The pH may be from, for example, 1 to 13, such as 8 to 11 depending on the nature of the composition. For example, a dishwashing composition desirably has a pH of 8 to 11, a laundry composition desirably has a pH of 7 to 9, and a water-softening composition desirably has a pH of 7 to 9.

One or more than one phase may be present. For example the container may be filled with an aqueous composition and a liquid composition which is immiscible with the aqueous composition. It may also be filled with an aqueous composition and a separate solid composition, for example in the form of a ball pill or speckles.

Thus the composition need not be uniform. For example, during manufacture of the container could first be filled with a settable composition, for example a gel, and then with a different composition. Each of these compositions is independently aqueous so long as at least one contains greater than 3 wt % free water. The first composition could dissolve slowly, for example in a washing process, so as to deliver its charge over a long period. This might be useful, for example, to provide an immediate, delayed or sustained delivery of a component such as a softening agent.

The containers may themselves be packaged in outer containers if desired, for example non-water soluble containers which are removed before the water-soluble containers are used.

In use the containers are simply added to water where they dissolve. Then they may be added in the usual way to a dishwasher or laundry machine, especially in the dishwashing compartment or drum. They may also be added to a quantity of water, for example in a bucket or trigger-type spray.

The present invention will now be further explained in the following Examples.

### EXAMPLE 1

A dishwashing composition was prepared by mixing together the following components in the weight proportions indicated:

| | |
|---|---|
| Potassium tripolyphosphate powder | 12% |
| Sodium tripolyphosphate powder | 30% |
| Isothiazolinone | 0.1% |
| Polyacrylate thickener (Carbopol) | 1% |
| Nonionic surfactant | 0.5% |
| Sodium citrate | 10% |
| Dehardened water | 46.4% |

A Multivac thermoforming machine operating at 6 cycles/min and at ambient conditions of 25° C. and 35% RH (±5% RH) was used to thermoform a PVOH film. This was Monosol M8534 obtained from Chris Craft Inc. Gary, Ind., USA, having a degree of hydrolysis of 88% and a thickness of 100 μm. The PVOH film was thermoformed into a rectangular mould of 39 mm length, 29 mm width and 16 mm depth, with the bottom edges being rounded to a radius of 10 mm, at 115-118° C. The thus formed pocket was filled with 10 ml of the dishwashing composition, and a 75 μm thick Monosol M8534 PVOH film was placed on top and heat sealed at 144-148° C. The thus produced containers were separated from each other by cutting the flanges. Each container was initially limp, but attained an attractive, rounded appearance after a few minutes.

### EXAMPLE 2

The following formulations were prepared by mixing together the indicated components in the weight proportions indicated. In all instances the compositions were filled into containers following the procedure described in Example 1, and containers having an attractive, rounded appearance were obtained.

A laundry detergent composition:

| | |
|---|---|
| Sodium carbonate | 20% |
| Nonylphenol ethoxylate | 10% |
| Accusol 820 obtainable from | 3.3% |
| Rohm and Haas Company | |
| Sodium citrate | 5% |
| Dehardened water | 61.7% |

An automatic dishwasher detergent:

| | |
|---|---|
| Sodium citrate | 8% |
| Van Gel ES thickener obtainable | 4% |
| from R. T. Vanderbilt Company | |
| Tetrapotassium pyrophosphate | 10% |
| Sodium tripolyphosphate | 30% |
| Anhydrous sodium metasilicate | 2% |
| Sodium xylene sulfonate | 2.25% |
| Deceth-4-phosphate | 0.75% |
| Dehardened water | 43% |

A slurry-type heavy duty laundry liquid

| | |
|---|---|
| Neodol 25-7 C₁₂₋₁₅ lineal alcohol | 18% |
| Biosoft D-62 sodium | 5.5% |
| alkylbenzenesulfonate | |
| Sodium carbonate | 2% |
| Anhydrous sodium metasilicate | 5% |
| Tetrasodium pyrophosphate | 20% |
| Sodium citrate | 7.5% |
| Carbopol ETDZ691 polymer | 0.5% |
| obtainable from Goodrich | |
| Dehardened water | 41.5% |

A slurry-type laundry detergent:

| | |
|---|---|
| Sodium carbonate | 40% |
| Sodium citrate | 4.8% |
| Accusol 820 obtainable from | 2% |
| Rohm and Haas | |
| Accusol 810 obtainable from | 4% |
| Rohm and Haas | |
| Sodium tripolyphosphate | 10% |
| Accusol 445 obtainable from | 2% |
| Rohm and Haas | |
| Nonylphenol ethoxylate | 10% |
| Dehardened water | 27.2% |

A dishwashing composition:

| | |
|---|---|
| Accusol 810 | 11% |
| Accusol 445N | 4% |
| Sodium tripolyphosphate | 20% |
| Tetrapotassium pyrophosphate | 10% |
| Potassium silicate | 29% |
| Triton CF-32 alkylamine | 3% |
| ethoxylate | |
| Potassium citrate | 5% |
| Dehardened water | 18% |

1. A water-soluble container containing an aqueous composition, wherein:
a) the container comprises a thermoformed poly(vinyl alcohol) film; and
b) the aqueous composition is in contact with the film and contains greater than 3 wt % free water, based on the weight of the aqueous composition.

2. A container according to claim 1 wherein the aqueous composition is a fabric care, surface care or dishwashing composition.

3. A container according to claim 1 or 2 wherein the aqueous composition is a dishwashing, water-softening, laundry or detergent composition or is a rinse-aid.

4. A container according to any one of the preceding claims which is suitable for use in a domestic washing machine.

5. A container according to claim 1 or 2 wherein the aqueous composition is a disinfectant, antibacterial or antiseptic composition.

6. A container according to claim 1 or 2 wherein the aqueous composition is a refill composition for a trigger-type spray.

7. A container according to any one of the preceding claims wherein the aqueous composition comprises more than 6 wt % free water.

8. A container according to claim 7 wherein the aqueous composition comprises more than 20 wt % free water.

9. A container according to any one of the preceding claims wherein the thermoformed poly(vinyl alcohol) film is cold water (20° C.) soluble.

10. A container according to any one of the preceding claims which comprises two poly(vinyl alcohol) films sealed together.

11. A container according to any one of the preceding claims wherein the poly(vinyl alcohol) film has a water content of less than 5 wt %.

12. Use of a thermoformed poly(vinyl alcohol) film to package an aqueous composition containing greater than 3 wt % free water, based on the weight of the aqueous composition.

13. A process for producing a container as defined in any one of claims 1 to 11 which comprises:
a) thermoforming a first poly(vinyl alcohol) film to produce a pocket;
b) filling the pocket with the aqueous composition;
c) placing a second film on top of the filled pocket; and
d) sealing the first film and second film together.

14. A process according to claim 13 wherein the second film is a poly(vinyl alcohol) film.
